(19) United States
(12) Patent Application Publication
(10) Pub. No.: US 2005/0281430 A1
(43) Pub. Date: Dec. 22, 2005

(54) Speaker device

(76) Inventor: Tomoyuki Watanabe, Yamagata (JP)

Correspondence Address: YOUNG & THOMPSON, 745 SOUTH 23RD STREET, 2ND FLOOR, ARLINGTON, VA, 22202, US

(21) Appl. No.: 11/083,995

(22) Filed: Mar. 21, 2005

(30) Foreign Application Priority Data
Mar. 19, 2004 (JP) 2004-80155

(51) Int. Cl. H04R 25/00

(52) U.S. Cl. 381/396

(57) ABSTRACT

A speaker device includes a connecting member having a groove supporting an inner peripheral edge portion of a diaphragm. The groove is formed at an area in the vicinity of an upper end of an outer peripheral wall of a cylindrical portion, and is formed on the outer peripheral wall of the cylindrical portion along the circumferential direction. An adhesive is applied to the inside of the groove, and the inner peripheral edge portion of the diaphragm is inserted therein. Therefore, the inner peripheral edge portion of the diaphragm is securely fixed to the groove. According to such the structure, the area in the vicinity of the inner peripheral edge portion of the diaphragm is disposed not above the upper end surface of the connecting member and at the area in the vicinity of the lower end surface, but at a position substantially as high as the upper end surface.

### TECHNICAL FIELD

The present invention relates to a supporting structure of a diaphragm in a speaker device.

### BACKGROUND ART

Conventionally, there is known an internal magnet type speaker device including a magnetic circuit including a plate-shaped magnet, a planar plate and a pot type yoke, and a vibrating system including a tinsel cord connected to an input terminal, acorn-shape diaphragm, a damper, a connecting member made of a resin material, a voice coil, a voice coil bobbin and a frame.

In such the speaker device, the connecting member movably supports the voice coil bobbin. The connecting member has a cylindrical portion in a substantial cylindrical shape at a position opposite to an outer peripheral wall of the voice coil bobbin. Respective inner peripheral edge portions of the damper and the corn-shape diaphragm are fixed to an area in the vicinity of the lower end of the outer peripheral wall of the cylindrical portion via an adhesive.

However, in the above-mentioned speaker device, since a cap of the corn-shape diaphragm structurally covers the upper surface of the voice coil bobbin, a space is formed between the upper surface and the cap. Therefore, the cap is obstructive, and it is impossible to make the portion thin. As a result, making the entire speaker device thin is limited.

As the speaker device of this kind, there is known a speaker device in which an inner peripheral edge portion of a diaphragm is mounted not to a connecting member but to an upper end portion of an outer peripheral wall of a voice coil bobbin, which is located above the connecting member. In such the speaker device, since a space is formed between the inner peripheral edge portion of the diaphragm and the upper end portion of the connecting member, it is impossible to make an area in the vicinity of the inner peripheral edge portion of the diaphragm thin. As a result, similarly to the above-mentioned speaker device, making the entire speaker device thin is limited.

There is known a coaxial speaker in which a wiring structure and a wiring work can be simplified and the wiring can be automated (see Japanese Patent Application Laid-Open under No. 10-341491, for example).

### DISCLOSURE OF THE INVENTION

As an object to be achieved by the present invention, the above described object is cited as an example. The present invention has its object to provide a structure of a connecting member capable of making a speaker device thin.

According to one aspect of the present invention, there is provide a speaker device including: a frame: a damper which has an outer peripheral edge portion supported by the frame; a connecting member which is mounted to the damper, and which movably supports a voice coil bobbin; a diaphragm which is fixed to the connecting member, wherein a groove is formed at a portion in the vicinity of an upper end of an outer peripheral wall of the connecting member along a circumferential direction, and wherein an inner peripheral edge portion of the diaphragm is fixed to the connecting member via an adhesive applied to an inside of the groove.

In the above-mentioned speaker device, the groove is formed at the portion in the vicinity of the upper end of the outer peripheral wall of the connecting member along the circumferential direction. The inner peripheral edge portion of the diaphragm is fixed to the connecting member via the adhesive applied to the inside of the groove. The area in the vicinity of the inner peripheral edge portion of the diaphragm is disposed not above the upper end surface of the connecting member and in the area in the vicinity of the lower end portion thereof, but at the position substantially as high as the upper end surface. Therefore, the area in the vicinity of the inner peripheral edge portion of the diaphragm can be made thin, and the speaker device can be made thin, too.

In a preferred example, the inner peripheral edge portion of the diaphragm may have a portion bent on a side opposite to a sound emitting side, and the bent portion may be inserted into the groove. Thereby, it can be prevented that the inner peripheral edge portion of the diaphragm gets out of the groove during solidification of the adhesive. It becomes possible to securely fix the diaphragm to the connecting member.

In a form, the speaker device may further include: a tinsel cord; and a lead wire which is drawn out of a voice coil, wherein plural holes through which the tinsel cord passes are formed at a portion in a vicinity of the inner peripheral edge portion of the diaphragm, and wherein a portion in a vicinity of an end portion of the tinsel cord is exposed on an upper surface of the diaphragm with the tinsel cord passing through the plural holes, and the portion in the vicinity of the end portion of the tinsel cord is electrically connected to a portion in a vicinity of an end portion of the lead wire on the upper surface of the diaphragm.

In accordance with the form, the portion in the vicinity of the end portion of the tinsel cord and the portion in the vicinity of the end portion of the lead wire can be electrically connected on the upper surface in the vicinity of the inner peripheral edge portion of the diaphragm. It is noted that the electrical connection thereof can be performed by soldering, for example. Since the diaphragm is stably fixed to the connecting member via the adhesive in the groove of the connecting member, the work for electrically connecting the tinsel cord and the lead wire on the upper surface of the diagram can be securely performed.

### BRIEF DESCRIPTION OF THE DRAWINGS

FIG. 1 shows a sectional view of a speaker device according to an embodiment of the present invention;

FIG. 2 shows a sectional view of a connecting member according to this embodiment;

FIG. 3 shows a sectional view in which an area in the vicinity of an inner peripheral edge portion of a diaphragm is enlarged; and

FIG. 4 shows a plan view in which the area in the vicinity of the inner peripheral edge portion of the diaphragm is enlarged.

### BEST MODE FOR CARRYING OUT THE INVENTION

A preferred embodiment of the present invention will be explained with reference to the drawings hereinafter. This embodiment makes the area in the vicinity of the inner peripheral edge portion of the diaphragm thin by forming the groove at the portion in the vicinity of the upper end of the connecting member and fixing the inner peripheral edge portion of the diagram to the groove, and to make the speaker device thin.

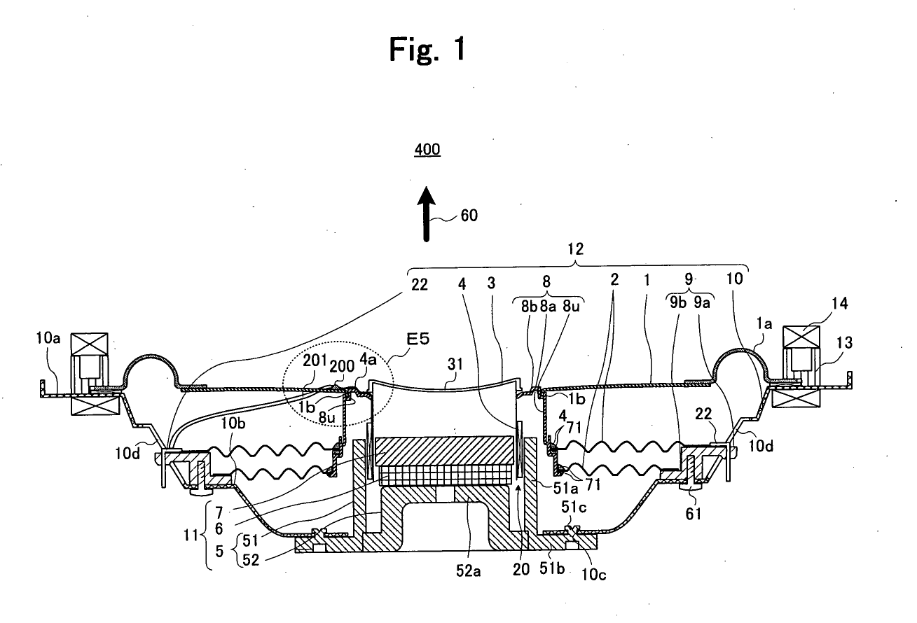

A general construction of a speaker device 400 according to the embodiment of the present invention will be schematically shown in FIG. 1. The speaker device 400 of this embodiment can be preferably used as an on-vehicle speaker. FIG. 1 shows a sectional view when cutting the speaker device 400 by a plane including a central axis thereof. A construction and the like of the speaker device 400 of this embodiment will be explained hereinafter with reference to FIG. 1.

As shown in FIG. 1, the speaker device 400 mainly includes a vibrating system 12 having a frame 10, a support member 9, a voice coil bobbin 3, a connecting member 8, a damper 2, terminal members 22, a diaphragm 1, a tinsel cord 201 and a voice coil 4, a magnetic circuit system 11 having a pot type yoke 5, a magnet 6 and a plate 7, an anti-dust cap 31, and other various kinds of members.

First, each component of the vibrating system 12 will be explained.

Various components of the speaker device 400 are fixed to the frame 10, and the frame 10 has the function of supporting these components. The frame 10 is made of a metal material of good thermal conductivity. Therefore, the frame 10 has the function as a medium for giving and receiving heat to and from an external space of the speaker device 400 and its internal space. The frame 10 is formed into a pan-shape or pot-shape which is opened upward, and has a first flange part 10a formed at the top part for supporting an outer peripheral edge portion and the like of the diaphragm 1, a second flange part 10b formed at an intermediate part for supporting the support member 9, openings 10c formed in an inner peripheral edge portion, and a plurality of openings 10d formed at a side wall between the first flange part 10a and the second flange part 10b. A plurality of openings 10c are formed with fixed spaces therebetween in a circumferential direction of the inner peripheral edge portion. Each of the projecting portions 51c of the pot type yoke 5 before deformation, which will be described later, is inserted into each of the openings 10c.

The support member 9 is formed of, for example, a resin material, and is formed into a substantially annular shape in the plane view. The support member 9 is formed into a step shape in the sectional view, and has a top surface 9a and a top surface 9b. The support member 9 is mounted to the second flange part 10b by a fixing member 61 such as a male screw and a bolt.

The voice coil bobbin 3 is formed into a substantially cylindrical shape. The voice coil 4 is wound around an outer peripheral wall of a lower end portion of the voice coil bobbin 3. The inner peripheral wall of the lower end portion of the voice coil bobbin 3 is opposed to outer peripheral walls of the planar magnet 6 and plate 7 with a fixed space from them. The outer peripheral wall of the lower end portion of the voice coil bobbin 3 is opposed to an outer peripheral wall of an upper end portion of a pole piece 5 at a fixed space from it. A clearance (magnetic gap 20) is formed between an inner peripheral wall of the upper end portion of the pole piece 5 and an outer peripheral wall of the plate 7.

The connecting member 8 is formed of, for example, a resin material, has a cylindrical portion 8a formed into a substantially cylindrical shape and a bent portion 8b formed in a fashion being bent inwardly from an upper end of the cylindrical portion 8a, and is made by integrally forming them. An inner peripheral edge portion of the connecting member 8, namely, an inner peripheral edge portion of the bent portion 8b is fixed to an area in the vicinity of the upper end of the outer peripheral wall of the voice coil bobbin 3. The structure of the connecting member 8, which is a characteristic of the present invention, will be explained later.

The plural dampers 2 are provided. In the plural dampers, the outer peripheral edge portion of the lower damper disposed on the lower side is fixed to the top surface 9b of the support member 9 via the adhesive, and the inner peripheral edge portion of the lower damper is fixed to the lower end portion of the connecting member 8 via the adhesive 71. Meanwhile, the outer peripheral edge portion of the upper damper disposed on the upper side is fixed to the top surface 9a of the support member 9 via the adhesive, and the inner peripheral edge portion of the upper damper is fixed to the portion in the vicinity of the lower end of the connecting member 8 via the adhesive 71. The terminal member 22 is a member having conductivity such as metal, and a plurality of terminal members 22 are provided. Each of the terminal members 22 is fixed to the top surface 9a of the support member 9. One end of each of the terminal members 22 is electrically connected to the tinsel cord 201 which will be described later, and the other end of each of the terminal members 22 is electrically connected to a relay wiring at an amplifier side not shown.

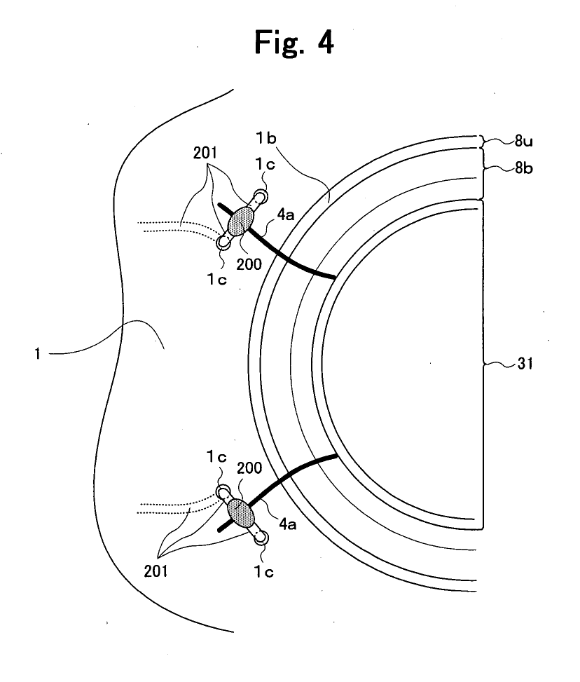

The diaphragm 1 is formed into a substantially planer shape. Various kinds of materials such as paper, polymer, and metal can be applied to the diaphragm 1 in accordance of the various kinds of use purposes. The edge portion 1a which is a separate piece from the diaphragm 1 is mounted to an outer peripheral edge portion of the diaphragm 1. The inner peripheral edge portion 1b of the diaphragm 1 is bent on the side opposite to the sound emitting side. Moreover, plural holes 1c (see FIG. 4) are formed at the area in the vicinity of the inner peripheral edge portion 1b of the diaphragm 1. The tinsel cord 201 passes through each hole. The outer peripheral edge portion of the diaphragm 1 is fixed to the first flange part 10a. Meanwhile, the inner peripheral edge portion 1b of the diaphragm 1 is fixed to the portion in the vicinity of the upper end of the connecting member 8, which will be described later.

The tinsel cord 201 is a member having the conductivity, and plural tinsel cords 201 are provided. One end of each tinsel cord 201 is electrically connected to each terminal member 22 via a soldering not shown. Meanwhile, the other end of each tinsel cord 201 passes from the side of the lower surface of the diaphragm 1 to the side of the upper surface thereof via the hole formed on the diaphragm 1, and is further sewn on and passes through the side of the lower surface again.

The voice coil 4 has a pair of positive/negative lead wires 4a. A lead wire at the positive side is an input wiring for an L (or R) channel signal, and a lead wire at the negative side is an input wiring for a ground (GND: ground) signal. Each lead wire 4a is drawn around the outer peripheral wall of the voice coil bobbin 3 and the upper surface of the bent portion 8b of the connecting member 8, and is further drawn around the area in the vicinity of the inner peripheral edge portion on the side of the upper surface of the diaphragm 1. Each lead wire 4a is electrically connected to the other end of the tinsel cord 201 via the soldering. Therefore, an electric signal of one channel is inputted from the amplifier side into the voice coil 4 via each of the terminal members 22, each of the tinsel cords 201 and each of the lead wires 4a.

Next, each component of the magnetic circuit 11 will be explained.

The magnetic circuit system 11 is constructed as the internal magnet type magnetic circuit. This magnetic circuit has the pot type yoke 5, the planar magnet 6 and the planar plate 7. The pot type yoke 5 has a body part 51 and a bottom part 52, and they are bonded together. The pot type yoke 5 is mounted on frame 10.

The body part 51 has a cylindrical portion 51a, a flange part 51b, and projecting portions 51c projecting upward from the top surface of the flange part 51b, and is formed by integrating them. The cylindrical portion 51a is formed into a substantially cylindrical shape. The cylindrical portion 51a extends upward from the area in the vicinity of the inner circumference of the flange part 51b to the position in the vicinity of the plate 7. The flange part 51b extends in the outward direction substantially perpendicularly from the position in the vicinity of the lower end of the outer peripheral wall of the cylindrical portion 51a. The inner peripheral edge portion of the frame 10 is mounted to the top surface of the flange part 51b. The projecting portion 51c is formed into the columnar shape and a plurality of projecting portions 51c are formed on the top surface of the flange part 51b with fixed spaces from each other. Each of the projecting portions 51c has the function of fixing the inner peripheral edge portion of the frame 10 by being caulked.

The bottom part 52 has the sectional shape of substantially inversed recessed shape. The bottom part 52 has a mounting portion 52a whose size is substantially the same as the diameters of the planer magnet 6 and the planar plate 7. The outer peripheral edge portion of the bottom part 52 is connected to the body part 51.

The planar magnet 6 is fixed onto the mounting portion 52a of the bottom part 52 of the pot type yoke 5. The planar plate 7 is fixed onto the magnet 6. In the magnetic circuit system 11, the magnetic circuit is constructed by the magnet 6 and the plate 7, and magnetic flux of the magnet 6 is concentrated at the magnetic gap 20 formed between the outer peripheral wall of the plate 7 and the inner peripheral wall of the pot type yoke 5.

The anti-dust cap 31 is mounted to the upper end portion of the voice coil bobbin 3 via the adhesive so as to close the top surface of the voice coil bobbin 3. Thereby, the anti-dust cap 31 has the function of preventing a foreign matter or the like from entering the inside of the speaker device 400.

Next, various kinds of component members will be explained.

Various kinds of component members include a packing 13, a buffer member 14 and the like.

The packing 13 is formed into an annular shape and is the member having insulating property. As the material for the packing 13, for example, a resin material is preferable. The bottom surface of the packing 13 is fixed to the first flange part 10a and the outer peripheral edge part of the edge portion 1a. Thereby, the outer peripheral edge part of the diaphragm 1 and the edge portion 1a is sandwiched by the packing 13 and the first flange part 10a.

The buffer member 14 has the function as the buffer material when the speaker device 400 is mounted to a predetermined position of the vehicle, for example, and has the function and the like of preventing the vibration from the outside from being transmitted to the body of the speaker device 400. Therefore, as the material of the buffer member 14, for example, a member having cushioning property such as sponge is preferable. The buffer member 14 has a rod shape before being mounted, and an adhesive is applied to one side surface, or a double-side adhesive tape is attached to one side surface. The buffer member 14 is attached on the upper surface of the packing 13 via the adhesive or the double-side adhesive tape in the state in which it is deformed in an annular shape.

In the speaker device 400 which is described above, an electric signal outputted from the amplifier is supplied to the voice coil 4 via each of the terminal members 22, each of the tinsel cords 201, and each of the lead wires 4a of the voice coil 4. Thereby, driving force occurs to the voice coil 4 in the magnetic gap 20, and vibrates the diaphragm 1 in the axial direction of the speaker device 400. Thus, the speaker device 400 emits acoustic waves in the direction of the arrow 60.

[Structure of Connecting Member Supporting Diaphragm]

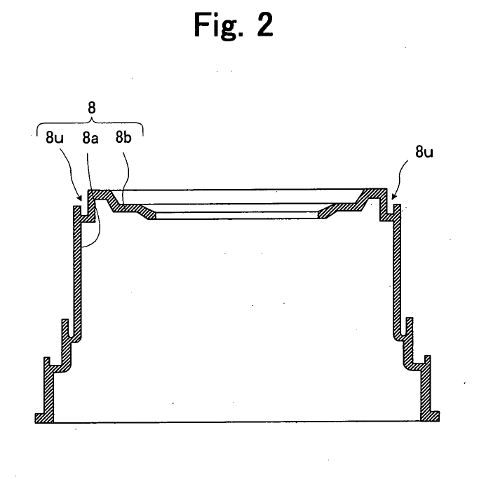

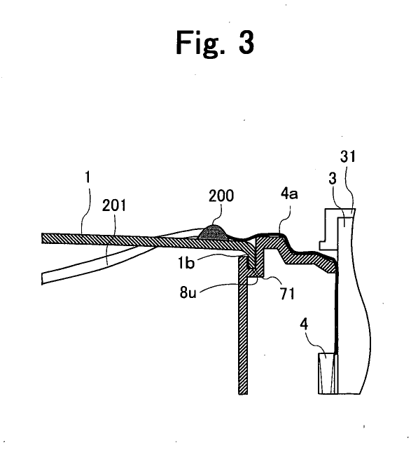

Next, the description will be given of the structure of the connecting member 8 capable of supporting the inner peripheral edge portion 1b of the diaphragm 1 and making the area in the vicinity of the inner peripheral edge portion 1b thin, with reference to FIG. 2 and FIG. 3. FIG. 2 shows a sectional view of the connecting member 8, which is a characteristic of the present invention. FIG. 3 shows a sectional view in which an area in the vicinity of an area E5 shown in FIG. 1 is enlarged.

The basic structure of the connecting member 8 is above described. Particularly, as shown in FIG. 2, the connecting member 8 which is the characteristic of the present invention has a groove 8u. The groove 8u is formed in the area in the vicinity of the upper end of the outer peripheral wall of the cylindrical portion 8a, and is formed on the outer peripheral wall of the cylindrical portion 8a along the circumferential direction. The adhesive 71 is applied to the inside of the groove 8u, and the inner peripheral edge portion of the diaphragm 1 is inserted therein. When the adhesive 71 is dried, the inner peripheral edge portion 1b of the diaphragm 1 is securely fixed to the groove 8u. FIG. 3 shows the state that the inner peripheral edge portion 1b of the diaphragm 1 is fixed to the groove 8u.

[Connecting Structure of Tinsel Cord and Lead Wire]

Next, the description will be given of a connecting structure of a tinsel cord 201 and a lead wire 4a with reference to FIG. 3 and FIG. 4. FIG. 4 shows an enlarged plan view in a case that the area in the vicinity of the area E5 shown in FIG. 1 is observed from the side of the upper surface of the diaphragm 1.

As shown in FIG. 4, plural holes 1c are formed in the area in the vicinity of the inner peripheral edge portion 1b of the diaphragm 1. As described above, each tinsel cord 201 is sewn on to and passes through each hole 1c. Concretely, each tinsel cord 201 passes through one hole 1c of the pair of holes 1c from the side of the bottom surface of the diaphragm 1 to be drawn out on the side of the upper surface of the diaphragm 1, and each drawn tinsel cord 201 further passes through the other hole 1c to pass through the side of the bottom surface of the diaphragm 1 again. Thereby, a portion in the vicinity of the edge portion of each tinsel cord 201 is exposed on the upper surface of the diaphragm 1.

On the other hand, as shown in FIG. 3 and FIG. 4, each lead wire 4a drawn out of the voice coil 4 is drawn around the outer peripheral wall of the voice coil bobbin 3 and the upper surface of the bent portion 8b of the connecting member 8, and is further drawn around the position in the vicinity of the tinsel cord 201 exposed on the upper surface of the diaphragm 1. Each lead wire 4a is across each tinsel cord 201, and a position at which each lead wire 4a and each tinsel cord 201 cross is soldered by a soldering 200. In such the way, each lead wire 4a and each tinsel cord 201 are electrically connected to each other.

As described above, the inner peripheral edge portion 1b of the diaphragm 1 is fixed to the groove 8u of the connecting member 8 via the adhesive 71. Therefore, the area in the vicinity of the inner peripheral edge portion 1b of the diaphragm 1 is disposed not above the upper end surface of the connecting member 8 and at the area in the vicinity of the lower end surface, but at the position substantially as high as the upper end surface. Thus, the area in the vicinity of the inner peripheral edge portion 1b of the diaphragm 1 can be made thin, and the speaker device 400 can be made thin, too.

Each tinsel cord 201 and each lead wire 4a are electrically connected to each other on the upper surface of the diaphragm 1 via the soldering 200. As described above, since the diaphragm 1 is attached to the inside of the groove 8u of the connecting member 8 to be stably fixed, the work for connecting the tinsel cord 201 and the lead wire 4a on the upper surface of the diaphragm by soldering can be securely performed.

1. A speaker device comprising:
a frame:
a damper which has an outer peripheral edge portion supported by the frame;
a connecting member which is mounted to the damper, and which movably supports a voice coil bobbin;
a diaphragm which is fixed to the connecting member,
wherein a groove is formed at a portion in the vicinity of an upper end of an outer peripheral wall of the connecting member along a circumferential direction, and
wherein an inner peripheral edge portion of the diaphragm is fixed to the connecting member via an adhesive applied to an inside of the groove.

2. The speaker device according to claim 1, wherein the inner peripheral edge portion of the diaphragm has a portion bent on a side opposite to a sound emitting side, and the bent portion is inserted into the groove.

3. The speaker device according to claim 1, further comprising:
a tinsel cord; and
a lead wire which is drawn out of a voice coil,
wherein plural holes through which the tinsel cord passes are formed at a portion in a vicinity of the inner peripheral edge portion of the diaphragm, and
wherein a portion in a vicinity of an end portion of the tinsel cord is exposed on an upper surface of the diaphragm with the tinsel cord passing through the plural holes, and the portion in the vicinity of the end portion of the tinsel cord is electrically connected to a portion in a vicinity of an end portion of the lead wire on the upper surface of the diaphragm.
